(19) United States
(12) Patent Application Publication
(10) Pub. No.: US 2004/0000058 A1
(43) Pub. Date: Jan. 1, 2004

(54) Tool device having changeable tool members

(76) Inventor: Hway Jeng Shyr, Taichung (TW)

Correspondence Address: Hway Jeng SHYR, P.O. Box 63-298, Taichung, 406, TW

(21) Appl. No.: 10/184,976

(22) Filed: Jul. 1, 2002

(51) Int. Cl. B26B 13/00

(52) U.S. Cl. 30/262; 30/261; 30/254

(57) ABSTRACT

A tool device includes a pair of pivotal levers, and two handles having one end detachably and quickly secured to the levers with quick release devices without additional tools. A spring may be secured between the levers before the levers are secured to the handles. The handles may be detachably secured to the other pairs of pivotal levers. The quick release devices each includes a pin engaged in one end of a shank, and a bar having an oblong hole for slidably receiving the pin, and for allowing the bar to be rotated between a release position and a lock position.

### BACKGROUND OF THE INVENTION

1. Field of the Invention

The present invention relates to a tool, and more particularly to a tool having detachable or changeable tool heads or tool members.

2. Description of the Prior Art

Typical tools, such as the typical pruning or shear devices, comprise a pair of jaws or cutter blades provided on one end, and a pair of handles on the other end for actuating or operating the cutter blades toward or away from each other.

U.S. Pat. No. 79,191 to Bergner, U.S. Pat. No. 352,561 to Neff, Jr., U.S. Pat. No. 670,416 to Cronk, U.S. Pat. No. 1,299,104 to Arnold, U.S. Pat. No. 1,557,401 to Barrett, U.S. Pat. No. 2,396,583 to Lenk et al., U.S. Pat. No. 3,834,022 to Students, U.S. Pat. No. 5,263,254 to Orthey, and U.S. Pat. No. 5,367,774 to Labarre et al., discloses some of the typical pruning or shear devices.

Some of the typical pruning or shear devices comprise one of the two cutter blades that may be detached or changed with the other cutter blades. However, additional tool members are required for securing the cutter blades to the typical pruning or shear devices.

U.S. Pat. No. 6,131,495 to Chen, U.S. Pat. No. 6,223,374 to Lin, and U.S. Pat. No. 6,336,387 to Lee disclose the other typical tools, such as the typical plier devices which comprise a pair of jaws and a pair of handles that may be easily and quickly secured together without additional tools. The jaws may be loosened and disengaged from the handles inadvertently.

The present invention has arisen to mitigate and/or obviate the afore-described disadvantages of the conventional tools.

### SUMMARY OF THE INVENTION

The primary objective of the present invention is to provide a tool including a quick release device for quickly and solidly and detachably or changeably securing the tool heads or tool members to the handles, without additional tools.

In accordance with one aspect of the invention, there is provided a tool device comprising a tool member including a pair of levers having a middle portion pivotally secured together, the levers each including a first end having a blade provided thereon, and each including a second end having an orifice formed therein, a pair of handles each including a first end having an orifice formed therein and aligned with the orifices of the levers respectively, and a pair of quick release devices each including a shank engaged through the orifices of the levers and the handles, for detachably securing the levers to the handles without additional tools. The levers may be assembled or secured together as a complete unit before quickly and detachably secured to the handles.

The shanks of the quick release devices each includes a first end having an enlarged head formed thereon, and a second end having a pin secured therein, and a bar having an oblong hole formed therein for slidably receiving the pin.

The bar includes a first end and a middle portion having the oblong hole formed between the first end and the middle portion thereof, the bar is rotatable relative to the shank when the pin is engaged in the first end of the bar, and the bar is perpendicular to the shank and engaged with the handle when the pin is engaged in the middle portion of the bar.

The quick release devices each includes a spring engaged between the shank and the handle for biasing the bar to engage with the handle..

The second ends of the shanks each includes a slot formed therein for receiving the bar, the pin is engaged through the slot of the shank and slidably engaged in the oblong hole of the bar.

The tool member includes a stop secured to a first of the levers, and a cavity formed in a second of the levers, a first end of the spring is engaged with the stop, and a second end of the spring is engaged into the cavity of the second lever.

The tool member includes a fastener engaged through the middle portions of the levers, and a lock nut threaded to the fastener and having a fence for engaging with the levers, and for forming a space between the lock nut and the levers, and for receiving the spring in the space thereof.

The middle portion of a first of the levers includes a circular aperture formed therein, the middle portion of a second of the levers includes a non-circular aperture formed therein, the fastener includes a cylindrical segment rotatably engaged in the circular aperture of the first lever, and a non-circular segment engaged in the non-circular aperture of the second lever.

The first ends of the handles each includes a pair of flaps provided therein and a channel formed between the flaps for receiving the second ends of the levers respectively, and a gasket engaged in the channel and engaged between a first of the flaps and the second end of the lever respectively.

One of the levers includes a lock shoulder provided therein, the tool member includes a latch pivotally secured to the other lever and having an actuator selectively engageable with the lock shoulder of the first lever, for locking the levers together.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a tool in accordance with the present invention;

FIG. 2 is an upper perspective view of the tool;

FIG. 3 is a bottom perspective view of the tool;

FIG. 4 is a partial bottom view of the tool;

FIG. 5 is a partial cross sectional view taken along lines 5-5 of FIG. 4;

FIGS. 6, 7 are partial cross sectional views similar to FIG. 5, illustrating the operation of the tool;

FIG. 8 is a perspective view illustrating the other tool heads or tool members that may be changeably attached or secured or assembled to the handles;

FIG. 9 is a bottom perspective view illustrating the attachment of the other tool heads or tool members to the handles; and

FIGS. 10 and 11 are partial top views illustrating the operation of the tool.

### DETAILED DESCRIPTION OF THE PREFERRED EMBODIMENT

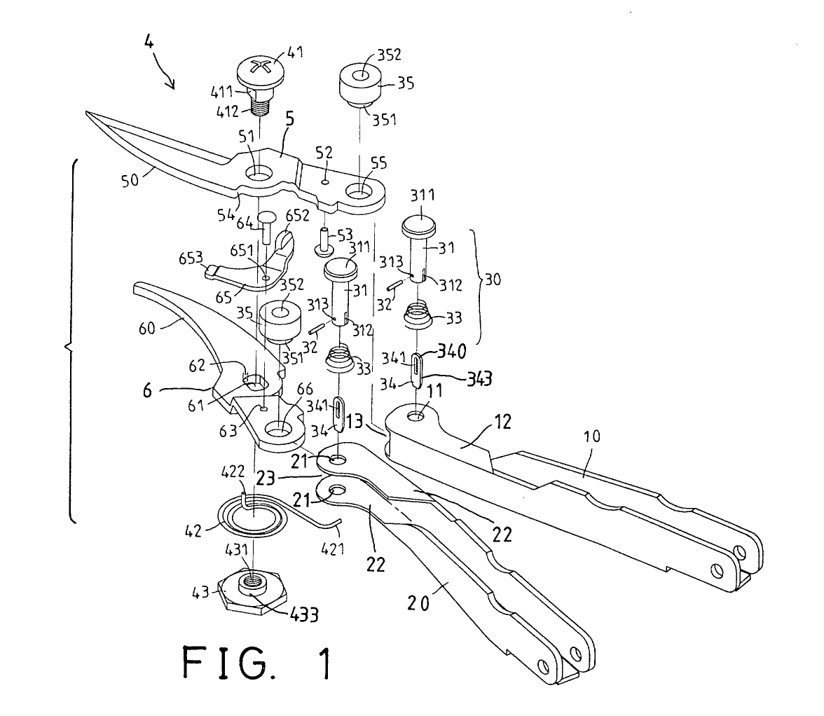

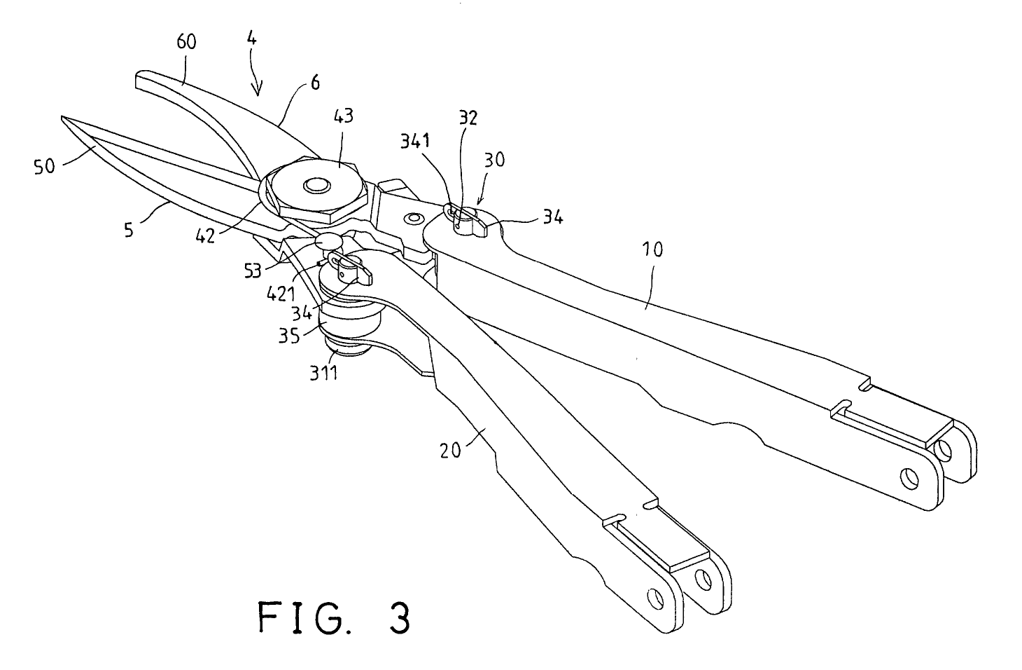

Referring to the drawings, and initially to FIGS. 1-5, a tool in accordance with the present invention comprises a pair of handles 10, 20 to be detachably and changeably secured to a tool head or a tool member 4 by quick release devices 30, and will not be disengaged from the tool member 4 inadvertently.

The handles 10, 20 each includes an orifice 11, 21 formed in one end thereof. For example, the handles 10, 20 each includes a pair of flaps 12, 22 formed in the one end thereof, and each having the orifice 11, 21 formed therein, and a channel 13, 23 formed or defined between the flaps 12, 22.

The tool member 4 includes a pair of levers 5, 6 each having a jaw or a blade, such as a cutter blade 50, 60 formed on one end thereof, and the other end rotatably or pivotally secured to the one end of the handles 10, 20, with the quick release devices 30 respectively.

The lever 5 includes an aperture 51 formed in the middle portion thereof, a hole 52 and an orifice 55 formed in the other end thereof, and includes a lock shoulder 54 formed and provided in the middle portion thereof. The orifice 55 of the lever S is aligned with the orifice 11 of the handle 10, for example.

The other lever 6 includes a non-circular aperture 61 and a cavity 62 formed in the middle portion thereof, a hole 63 and an orifice 66 formed in the other end thereof. The orifice 66 of the lever 6 is aligned with the orifice 21 of the handle 20, for example.

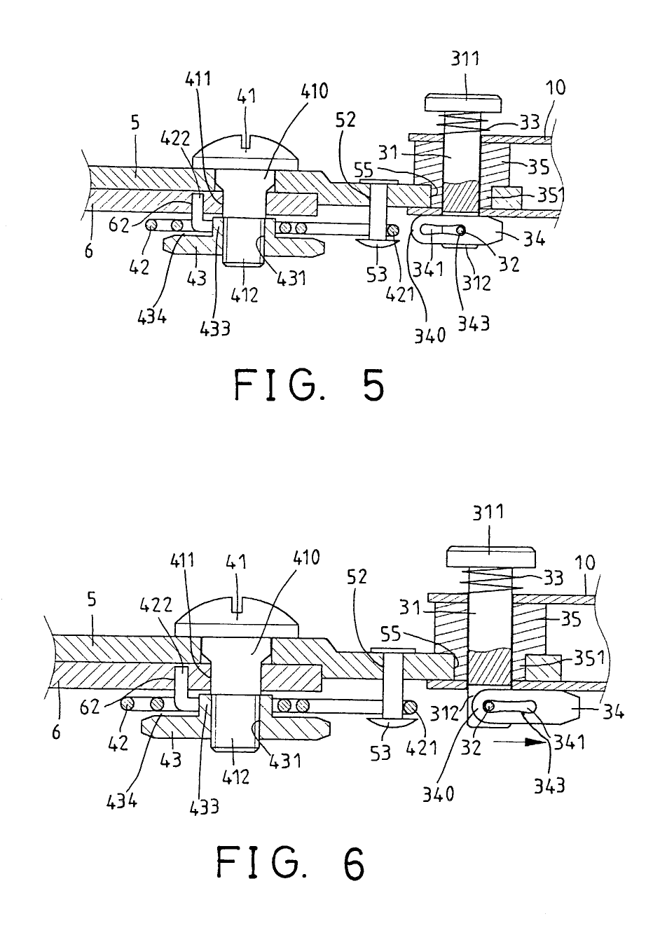

A fastener 41 is engaged through the apertures 51, 61 of the levers 5, 6, and includes a cylindrical segment 410 (FIGS. 5-7) rotatably received or engaged in the circular aperture 51 of the lever 5, and a non-circular intermediate segment 411 engaged in the corresponding non-circular aperture 61 of the other lever 6, such that the levers 5, 6 may be rotated relative to each other.

The fastener 41 further includes a threaded segment 412 outwardly extended through the apertures 51, 61 of the levers 5, 6, and and threaded to an inner thread 431 of a lock nut 43, such that the levers 5, 6 may be rotatably secured together with the fastener 41 and the lock nut 43.

It is to be noted that the aperture 61 of the lever 6 and the intermediate segment 411 of the fastener 41 may also include a circular cross section for mating or engaging with each other, and for also rotatably securing the levers 5, 6 together.

The lock nut 43 preferably or optionally includes a cylindrical fence 433 extended therefrom and engaged with the lever 6 (FIGS. 5-7) for forming or defining a gap or a space 434 between the lock nut 43 and the lever 6, for receiving a spring member 42, such as a coil spring 42 therein.

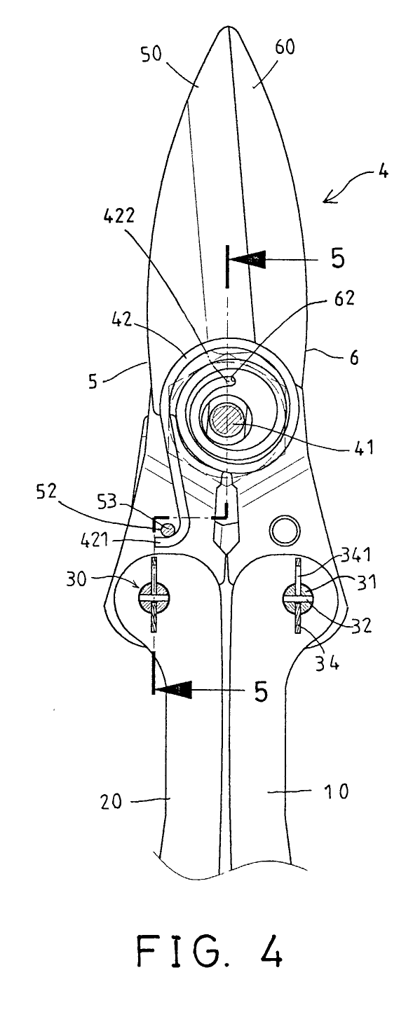

For example, the coil spring 42 is received in the space 434 defined between the lock nut 43 and the lever 6, and includes one end 421 engaged with a stop 53 that is engaged in the hole 52 of the lever 5, and the other end 422 engaged into the cavity 62 of the other lever 6, for biasing the blades 50, 60 of the levers 5, 6 toward each other, best shown in FIG. 4.

A pair of blocks 35 may further be provided and engaged between the other ends of the levers 5, 6 and one of the flaps 12, 22 of the handles 10, 20, and each includes a barrel 351 extended therefrom and engaged into the orifice 11, 21 of the other flaps 12, 22, and a bore 352 formed therein and aligned with the orifices 11, 55; 21, 66 for receiving the quick release devices 30 respectively.

Alternatively, the other ends of the levers 5, 6 may be formed to have a thickness equals to that of the channel 13, 23 formed or defined between the flaps 12, 22, for directly and snugly engaged between the flaps 12, 22 without the blocks 35.

The quick release devices 30 each includes a shank 31 rotatably engaged through the orifices 11, 55; 21, 66 of the handles 10, 20 and the levers 5, 6 respectively, for rotatably or pivotally coupling the other ends of the levers 5, 6 and the handles 10, 20 together.

The shanks 31 each includes an enlarged head 311 formed on one end thereof for engaging with the handles 10, 20 respectively, and a slot 312 and a hole 313 formed in the other end thereof. A pin 32 is engaged through the hole 313 of each of the shanks 31, and engaged or extended through the slots 312 of the shanks 31 respectively.

A pair of bars 34 are slidably received in the slots 312 of the shanks 31 respectively, and each includes an oblong hole 341 formed therein for slidably receiving the pin 32, and for limiting the sliding movement of the bars 34 relative to the shanks 31 respectively.

The oblong holes 341 of the bars 34 are preferably formed in one half of the respective bars 34, or are formed between one end 340 and the middle portion 343 of the bars 34 respectively, for allowing the pin 32 to be moved between the one end 340 and the middle portion 343 of the bar 34 (FIGS. 5-7).

Alternatively, the pin 32 may be moved between the one end 340 and the middle portion 343 of the bar 34 for allowing the bar 34 to be rotated between a release position parallel to the shank 31 or perpendicular to the handle 10, 20, and a lock position perpendicular to the shank 31 or parallel to the handle 10, 20.

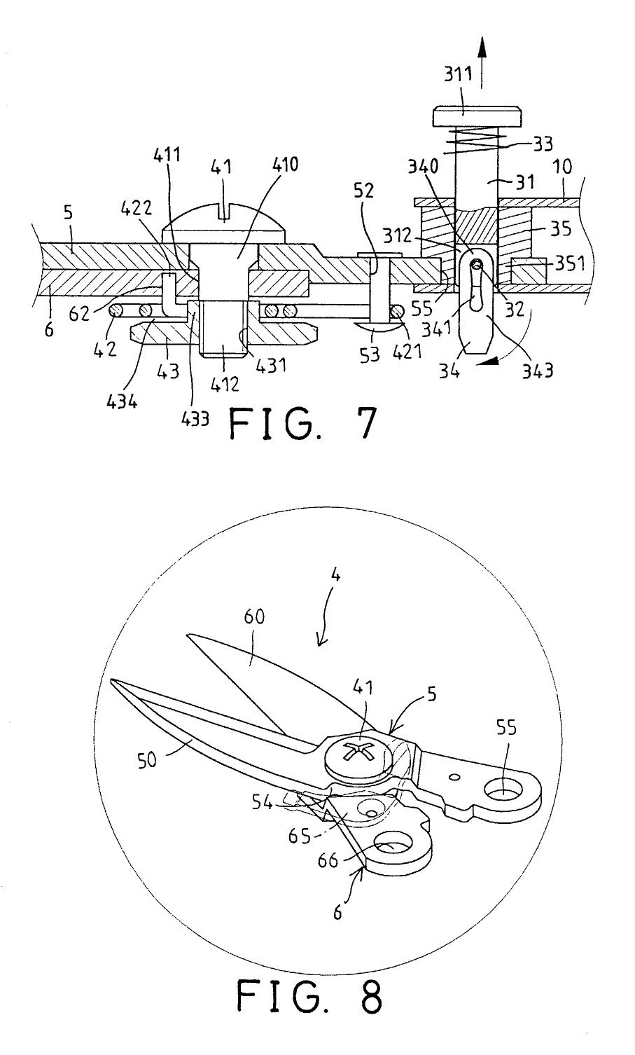

In operation, as shown in FIG. 7, when the pin 32 is moved to and engaged in the one end 340 of the bar 34, the bar 34 may be rotated to be aligned with or parallel to the shank 31, for allowing the bar 34 and the shank 31 to be engaged through the orifices 11, 55; 21, 66 of the handles 10, 20 and the levers 5, 6.

As shown in FIG. 6, when the bar 34 is rotated relative to the pin 32 to engage with the handle 10, or 20, the bar 34 may be moved relative to the pin 32 for engaging or moving the pin 32 to the middle portion 343 of the bar 34 (FIG. 5), and for locking the shank 31 to the handle 10, 20 respectively.

A spring 33 may further be provided and engaged between the head 311 and the respective handles 10, 20 for biasing the bars 34 toward or to engage with the handles 10, 20 respectively. The levers 5, 6 may thus be easily and quickly and detachably or changeably secured to the handles 10, 20 with the quick release devices 30.

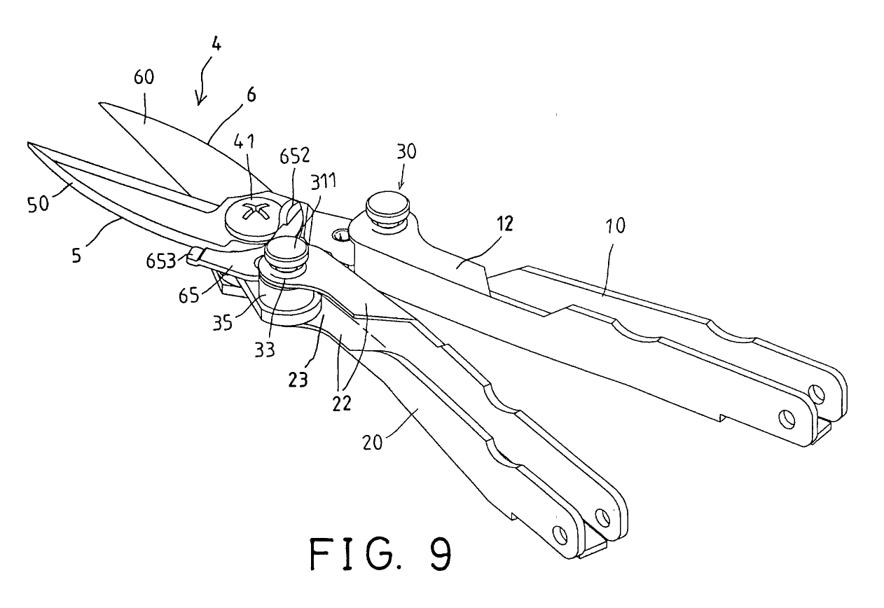

Referring next to FIGS. 8 and 9, the other pairs of tool members 4 may also be easily and quickly and detachably or changeably secured to the handles 10, 20 with the quick release devices 30, for allowing the pairs of tool members 4 to be quickly changed with each other, without additional tools.

It is to be noted that the spring 42 may be solidly secured between the levers 5, 6 with the lock nut 43, such that the levers 5, 6 of the pairs of tool members 4 may be assembled together as a complete unit before coupling to the handles 10, 20 with the quick release devices 30.

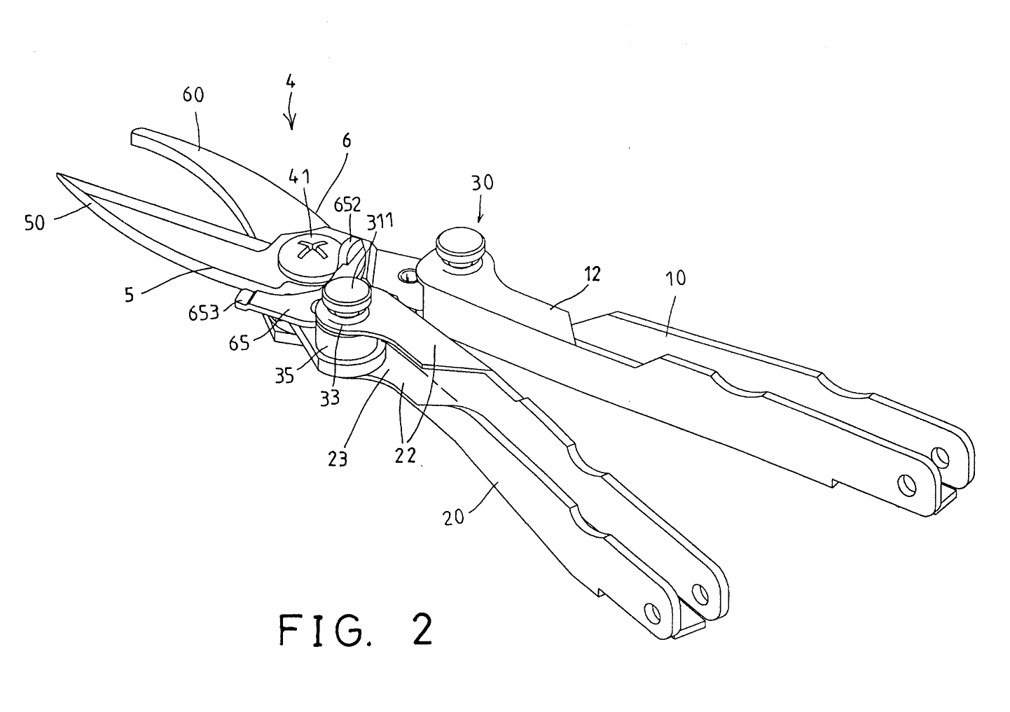

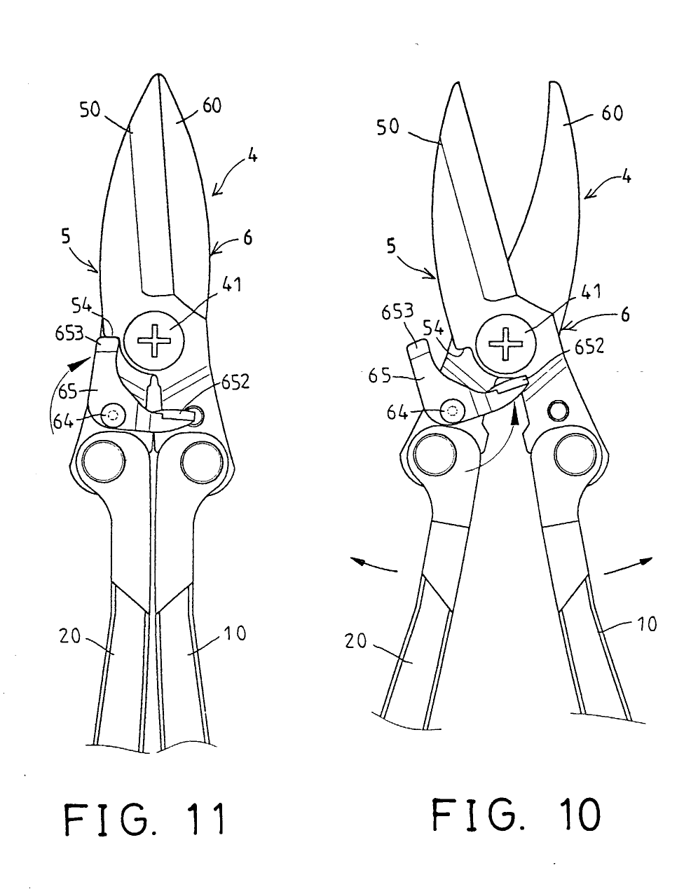

Referring next to FIGS. 10 and 11, and again to FIGS. 1 and 2, a latch 65 may further or optionally be provided and includes a hole 651 formed in the middle portion thereof for rotatably or pivotally secured to one of the levers 5, 6 with a pivot shaft 64, which may be engaged in the hole 63 of the lever 6.

The latch 65 includes an actuator 653 provided on one end thereof for selectively engaging with the lock shoulder 54 of the lever 5 (FIG. 11), for locking the levers 5, 6, such as the blades 50, 60 together, and for preventing the blades 50, 60 from being opened relative to each other.

The latch 65 includes a hand grip 652 formed or provided on the other end for selectively disengaging the actuator 653 from the lock shoulder 54 of the lever 5 (FIG. 10), and for allowing the blades 50, 60 of the levers 5, 6 to be opened relative to each other.

Accordingly, the tool in accordance with the present invention includes one or more pairs of tool members that may be easily and quickly and solidly and detachably or changeably secured to the handles with the quick release devices 30, without additional tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool device comprising:
a tool member including a pair of levers having a middle portion pivotally secured together, said levers each including a first end having a blade provided thereon, and each including a second end having an orifice formed therein,
a pair of handles each including a first end having an orifice formed therein and aligned with said orifices of said levers respectively, and
a pair of quick release devices each including a shank engaged through said orifices of said levers and said handles, for detachably securing said levers to said handles without additional tools.

2. The tool device according to claim 1, wherein said shanks of said quick release devices each includes a first end having an enlarged head formed thereon, and a second end having a pin secured therein, and a bar having an oblong hole formed therein for slidably receiving said pin.

3. The tool device according to claim 2, wherein said bar includes a first end and a middle portion having said oblong hole formed between said first end and said middle portion thereof, said bar is rotatable relative to said shank when said pin is engaged in said first end of said bar, and said bar is perpendicular to said shank and engaged with said handle when said pin is engaged in said middle portion of said bar.

4. The tool device according to claim 2, wherein said quick release devices each includes a spring engaged between said shank and said handle for biasing said bar to engage with said handle.

5. The tool device according to claim 2, wherein said second ends of said shanks each includes a slot formed therein for receiving said bar, said pin is engaged through said slot of said shank and slidably engaged in said oblong hole of said bar.

6. The tool device according to claim 1, wherein said tool member includes a spring having two ends engaged with said levers for being biased between said levers.

7. The tool device according to claim 6, wherein said tool member includes a stop secured to a first of said levers, and a cavity formed in a second of said levers, a first end of said spring is engaged with said stop, and a second end of said spring is engaged into said cavity of said second lever.

8. The tool device according to claim 6, wherein said tool member includes a fastener engaged through said middle portions of said levers, and a lock nut threaded to said fastener and having a fence extended therefrom for engaging with said levers, and for forming a space between said lock nut and said levers, and for receiving said spring in said space thereof.

9. The tool device according to claim 1, wherein said tool member includes a fastener engaged through said middle portions of said levers, for pivotally securing said middle portions of said levers together.

10. The tool device according to claim 9, wherein said middle portion of a first of said levers includes a circular aperture formed therein, said middle portion of a second of said levers includes a non-circular aperture formed therein, said fastener includes a cylindrical segment rotatably engaged in said circular aperture of said first lever, and a non-circular segment engaged in said non-circular aperture of said second lever.

11. The tool device according to claim 1, wherein said first ends of said handles each includes a pair of flaps provided therein and a channel formed between said flaps for receiving said second ends of said levers respectively, and a gasket engaged in said channel and engaged between a first of said flaps and said second end of said lever respectively.

12. The tool device according to claim 1, wherein a first of said levers includes a lock shoulder provided therein, said tool member includes a latch pivotally secured to a second of said levers and having an actuator selectively engageable with said lock shoulder of said first lever, for locking said levers together.

13. A tool device comprising:
a tool member including a pair of levers having a middle portion pivotally secured together, said levers each including a first end having a blade provided thereon, and each including a second end,
a pair of handles each including a first end detachably secured to said second ends of said levers respectively,
a spring including two ends engaged with said levers for being biased between said levers, and
a fastener engaged through said middle portions of said levers, and engaged with said spring for securing said spring to said levers.

14. The tool device according to claim 13, wherein said tool member includes a stop secured to a first of said levers, and a cavity formed in a second of said levers, a first end of said spring is engaged with said stop, and a second end of said spring is engaged into said cavity of said second lever.

15. The tool device according to claim 13, wherein said tool member includes a lock nut threaded to said fastener and having a fence extended therefrom for engaging with said levers, and for forming a space between said lock nut and said levers, and for receiving said spring in said space thereof.

16. The tool device according to claim 13, wherein said middle portion of a first of said levers includes a circular aperture formed therein, said middle portion of a second of said levers includes a non-circular aperture formed therein, said fastener includes a cylindrical segment rotatably engaged in said circular aperture of said first lever, and a non-circular segment engaged in said non-circular aperture of said second lever.

17. The tool device according to claim 13 further comprising a pair of quick release devices detachably securing said first ends of said handles and said second ends of said levers together.

18. The tool device according to claim 17, wherein said quick release devices each includes a shank engaged through said first ends of said handles and said second ends of said levers, said shanks each includes a first end having an enlarged head formed thereon, and a second end having a slot formed therein and a pin secured therein and engaged through said slot thereof, and a bar received in said slot of said shank and having an oblong hole formed therein for slidably receiving said pin.

19. The tool device according to claim 18, wherein said bar includes a first end and a middle portion having said oblong hole formed between said first end and said middle portion thereof for slidably receiving said pin.
